(19) United States
(12) Patent Application Publication
(10) Pub. No.: US 2023/0329481 A1
(43) Pub. Date: Oct. 19, 2023

(54) GRILL PLATE FOR OVEN WITH DRAINING FEATURE

(71) Applicant: Sunbeam Products, Inc., Boca Raton, FL (US)

(72) Inventors: Wai-Shun Chan, Kowloon (HK); Joseph Maikisch, Palm Beach Gardens, FL (US); Daniel Sumser, Lake Worth, FL (US); Sam Ho, Kowloon Bay (HK)

(21) Appl. No.: 18/302,088

(22) Filed: Apr. 18, 2023

Related U.S. Application Data
(60) Provisional application No. 63/363,218, filed on Apr. 19, 2022.

(51) Int. Cl. A47J 36/34; A47J 37/06

(52) U.S. Cl. CPC A47J 36/34; A47J 37/0694; A47J 37/067

(57) ABSTRACT

A grill plate configured for use within an oven is provided that includes a cooking surface and one or more projection members projecting outwardly from the cooking surface. The one or more projection members may be configured to abut a support element within the oven. Further, when the one or more projection members abut the support element, the cooking surface may slope downwardly from a rear side toward a front side of the cooking surface. That way, cooking byproducts, like grease, may be directed forwardly toward drain holes provided near the front side of the grill plate. The cooking byproducts may then be collected in drain pans located below the drain holes.

### CROSS-REFERENCE TO RELATED APPLICATIONS

The present application claims priority to U.S. Provisional Patent Application No. 63/363,218, filed Apr. 19, 2022, the entire contents of which are hereby incorporated by reference.

### FIELD OF THE INVENTION

The present invention relates generally to a grill plate for use in an oven. More particularly, the invention relates to a grill plate that can be placed on a wire rack in an oven such that it is secured in a specific position on the wire rack to facilitate grease or other cooking byproducts draining to specific locations.

### BACKGROUND OF THE INVENTION

Grill plates are frequently used in countertop ovens. The grill plates may be provided with either substantially flat or grill-like raised cooking surfaces. When the grill plate is in an oven, heat generated within the oven may heat up the grill plate such that food placed on the grill plate is heated primarily via direct heat transferred from the heated grill plate. In this manner, the grill plate operates to cook food similarly to a grill or a griddle.

When foods are cooked on a griddle, grease can accumulate on the grill plate. Grease collection on a hot grill plate may pool and smoke, creating an undesirable and potentially dangerous situation for a user. Drain holes in a grill plate may provide a solution to this issue, but drain holes require that the grill plate is coupled with a drain pan to collect the grease. However, placing a drain pan directly beneath the grill plate blocks radiant energy from reaching the grill plate. This reduces the surface temperature on the grill plate and leads to poor cooking performance. If a drain pan is not used, grease drains directly to the floor of an oven, potentially near the heating elements which can cause unwanted results such as excess smoking.

Existing solutions fail to address these concerns. Firstly, grill plates with drain holes require a pitch in order for grease to properly drain from the grill plate toward the drain holes. Existing solutions modify the plate thickness to produce a pitch; however, this causes variable plate thickness and potential surface temperature differences across the plate. This can also cause uneven, poor cooking. Secondly, double-tiered roasting pans allow for grease and fat to drip into lower areas. This solution is not optimal for grill cooking, because it leaves grease drippings below the cooking surface, between the grilling surface and the heating element. This leads to a higher surface temperature on the drain pan than on the grill plate. This ultimately causes a decrease in cooking performance and leads to an increase in smoke generation.

A simple solution is desired whereby grease is directed to a specific drain location without altering the cooking surface itself and without requiring the use of a grease collection pan that blocks heat transfer to the grill plate.

### SUMMARY OF THE INVENTION

The present invention provides a grill plate having a top surface and a bottom surface. The top surface includes a raised grill-like surface (like a grill) or a flat surface (like a plancha or a griddle) on which food can be cooked. The bottom surface, which sits on a wire rack of an oven when in use, includes feet that project downwardly from the bottom surface. The feet may be sized and shaped to couple the grill plate to the wire rack and tilt the grill plate at an angle. The angle may direct grease toward drain holes provided in the grill plate. The angle may be less than 10 degrees and is preferably less than 5 degrees. The feet may be sufficient to independently tilt the grill plate, or the feet may operate with other features to help tilt the grill plate.

The drain holes in the grill plate may be provided in a specific location and may align with a drainage area in the oven chamber intended to collect grease. Smaller collection pans may be used that align with the drain holes, and this alignment may reduce the need for a larger collection pan that blocks heat transfer from the heating element to the grill plate.

### BRIEF DESCRIPTION OF THE DRAWINGS

For a better understanding of the present invention, reference may be made to the following accompanying drawings.

FIG. 1 is a perspective view of a first embodiment of a grill plate constructed according to the teachings hereof.

FIG. 2 is a side elevation view of the grill plate of FIG. 1.

FIG. 3 is a perspective view of a second embodiment of a grill plate constructed according to the teachings hereof.

FIG. 4 is a side elevation view of the grill plate of FIG. 3.

### DETAILED DESCRIPTION OF THE INVENTION

A first embodiment of a grill plate 1 and a top surface 5 thereof is illustrated in FIG. 1. The grill plate 1 may include sidewalls 10 that may surround the perimeter of the grill plate 1. The sidewalls 10 may reduce the likelihood of food or cooking byproducts like grease contained within the grill plate 1 from spilling off of the grill plate 1. According to one embodiment, the grill plate 1 may also include raised ridges 15 which may reproduce grill marks on food being cooked. Such ridges may be absent when a griddle, instead of a grill, is desirable. The grill plate 1 may be generally rectangular and may be defined by a rear side 20, front side 25, and left and right sides 30, 35, respectively (when viewed from the front). The grill plate 1 may be preferably sized to fit in a countertop oven, though a nearly limitless number of sizes and configurations are foreseeable.

The grill plate 1 may be generally configured such that when it is placed on a wire rack of a countertop oven (not illustrated), the grill plate 1 tilts. The grill plate 1 may tilt forwardly from the rear side 20 toward the front side 25 such that grease generated during cooking also flows forwardly from the rear side 20 toward the front side 25. More specifically, drain holes 40 may be provided adjacent to the front side 25 through which grease may drain. The drain holes 40 of the grill plate 1 may be elongated oval-like slits, though in alternative embodiments may take on a number of shapes and sizes. The drain holes 40 may be preferably positioned such that a collection pan or other vessel may be placed below and in substantial alignment with the drain holes 40. The collection pan or pans (not illustrated) may be standalone devices or may be built into the oven chamber. They may be shaped and sized substantially similarly to the drain holes 40. In the illustrated embodiment, there are three drain holes 40, though more or fewer may be provided in alternative embodiments.

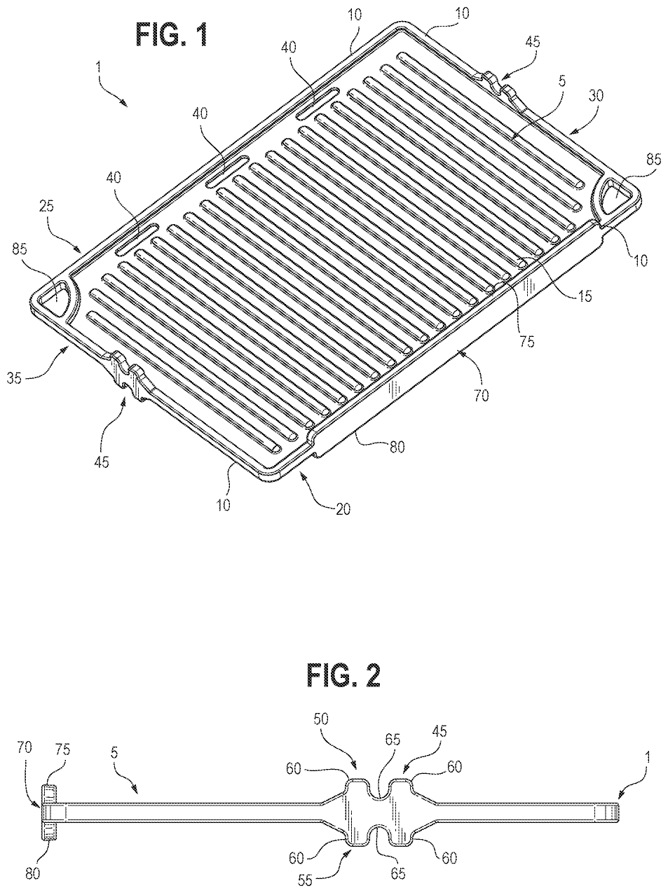

The grill plate 1 may preferably include two symmetrical leg members 45 extending downwardly from the left and right sides 30, 35 and may be located at or near a middle of the left and right sides 30, 35. One of the leg members 45 is illustrated in a side elevation view in FIG. 2. Each leg member 45 preferably includes each of a top portion 50 and a bottom portion 55. Each of the top portion 50 and bottom portion 55 may include two standoff portions 60 projecting outwardly therefrom. A curved recess 65 may be defined between the adjacent standoff portions 60. The curved recesses 65 of the leg members 45 may be preferably sized and shaped to receive and sit on a wire of a wire rack in a countertop oven (not illustrated).

The leg members 45 may preferably work in tandem with a wall member 70, which may be built into the rear side 20 of the grill plate 1. Like the leg members 45, the wall member 70 may be substantially symmetrical. The wall member 70 may include a top portion 75 and a bottom portion 80 that extend upwardly and downwardly, respectively, from the grill plate 1. The top portion 75 and bottom portion 80 may work in tandem to create a wall that is taller than the other sidewalls 10. The wall member 70 may prevent grease, which may collect near the wall member 70 due to the pitch of the grill plate 1, from spilling over the front side 25.

When the grill plate 1 sits on a wire rack in a countertop oven in the configuration embodied by FIG. 1, the recesses 65 may preferably engage the wires of the wire rack. In such a configuration, the bottom portion 80 of the wall member 70 sits on the wire rack. Because the bottom portion 80 may preferably project from the grill plate 1, the rear side 20 of the grill plate 1 may be preferably elevated relative to the rest of the grill plate 1. Such elevation may cause the grill plate 1 to generally slope downwardly from the rear side 20 toward the front side 25. The angle of the elevation may be less than 10 degrees, and in one embodiment, is preferably less than 5 degrees. More particularly, during cooking, the sloping surface may direct grease and other cooking byproducts forwardly toward the drain holes 40.

Grease may then fall through the drain holes 40 and into collection pans (not illustrated) positioned and located below the drain holes 40. Furthermore, the engagement between the recesses 65 and the wires of the wire rack may preferably create a repeatable mechanism to help ensure that the grill plate 1 is properly positioned. More specifically, when the recesses 65 engage a wire rack, the plate 1 may be positioned such that the drain holes 40 are properly positioned over collection pans, trays, or the like.

In the embodiment provided in FIGS. 1 and 2, the grill plate 1 is substantially reversible such that the top surface 5 faces downwardly and a bottom surface (not illustrated) becomes the top surface. The bottom surface may be identical to the top surface 5 and may include raised ridges 15 to reproduce grill marks or it may be substantially flat, like a griddle. The grill plate 1 may be substantially reversible because of the symmetries provided in the leg members 45 and the wall member 70. More particularly, when the grill plate 1 is reversed, the top portions 5 of the leg members 45 become the “bottom portions” engaged to the wire rack, and the top portion 75 of the wall member 70 sits on the wire rack when the grill plate 1 is in use, thus pitching the grill plate 1 forwardly.

The grill plate 1 of FIGS. 1 and 2 may further include apertures 85 located in corners of the grill plate 1. The apertures 85 may act as handles for carrying and otherwise manipulating the grill plate 1. While the embodiment of FIG. 1 includes two apertures 85, more or fewer apertures may be provided in alternative embodiments.

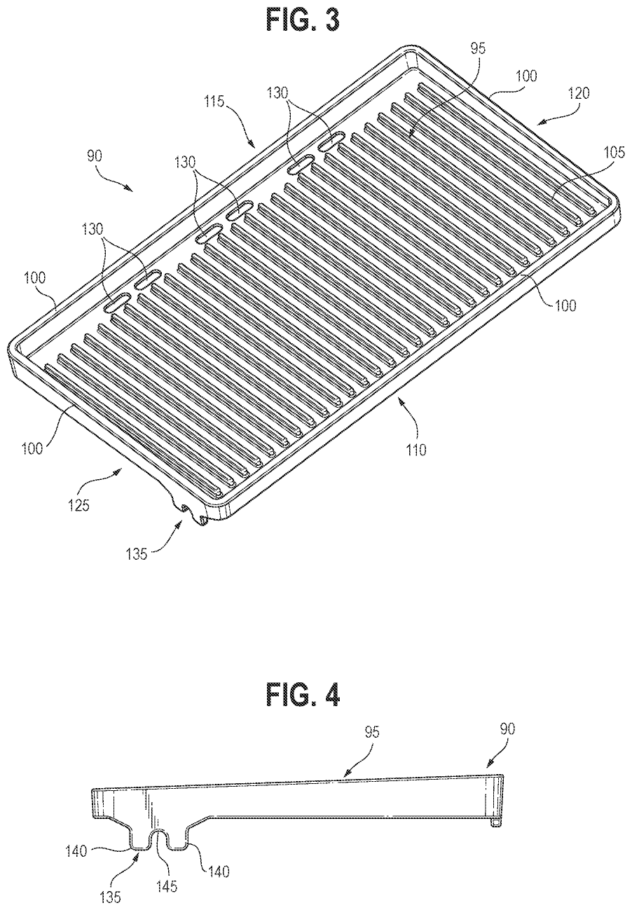

Turning now to FIG. 3, an alternatively constructed grill plate 90 is provided that, like the grill plate 1, includes a top surface 95 and sidewalls 100 that may surround its perimeter to help prevent grease from sloshing out of the grill plate 90. The grill plate 90 may include raised ridges 105 that can reproduce grill marks on food being cooked, though in alternative embodiments the ridges 105 may be omitted to provide a griddle-like cooking surface. The grill plate 90 may be substantially rectangular and may include a rear side 110, front side 115, and left and right sides 120, 125, respectively (when viewed from the front). The grill plate 90 may be preferably sized to fit in a countertop oven, though a nearly limitless number of sizes and configurations are foreseeable.

The grill plate 90 may be preferably configured to tilt forwardly from the rear side 110 toward the front side 115 when it is placed on an oven's wire rack. Drain holes 130 may be preferably provided adjacent to the front side 115 through which grease may drain when the grill plate 90 is in use. The drain holes 130, like the drain holes 40 of the grill plate 1, may be elongated oval-like slits. However, the drain holes 130, in the illustrated embodiment, are provided in three pairs of two drain holes. In alternative embodiments, the drain holes 130 may take on a nearly limitless number of shapes and sizes. The drain holes 130, like the drain holes 40, may be preferably positioned such that a collection pan or other vessel may be placed below the drain holes 130 in substantial alignment with the drain holes 130.

Unlike the grill plate 1, the grill plate 90 may include two leg members 135 extending downwardly from the left and right sides 120, 125 near the rear side 110 of the grill plate 90 (one leg member 135 is illustrated in side view in FIG. 4). Each leg member 135 may include two standoff portions 140 projecting downwardly and may include a curved recess 145 formed between the adjacent standoff portions 140. The curved recesses 145 may be preferably sized and shaped to sit on and couple to a wire of a wire rack (not illustrated) in a countertop oven.

Because the leg members 135 are located near a rear side 110 of the grill plate 90, when the grill plate 90 sits on a wire rack in a countertop oven, the recesses 145 may preferably engage the wires of the wire rack. The leg members 135 may “lift” the rear side 110 of the grill plate 90 relative to the rest of the grill plate 90. Thus, the grill plate 90 may generally slopes downwardly from the rear side 110 toward the front side 115. The angle of the slope may be less than 10 degrees, and in one embodiment, is preferably less than 5 degrees. The sloping surface may direct grease and other cooking byproducts forwardly toward the drain holes 130. Grease may then fall through the drain holes 130 and into collection pans (not illustrated) positioned and located below the drain holes 130.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles, and scope of the present invention.

Many changes, modifications, variations, and other uses and applications of the present invention will, however, become apparent to those skilled in the art after considering the specification and the accompanying drawings. All such changes, modifications, variations, and other uses and applications which do not depart from the spirit and scope of the invention are deemed to be covered by the invention, which is limited only by the claims which follow.

1. A grill plate configured for use within an oven, the grill plate comprising:
a cooking surface; and
one or more projection members projecting outwardly from the cooking surface, the one or more projection members configured to abut a support element within the oven;
wherein when the one or more projection members abut the support element, the cooking surface slopes downwardly from a rear side toward a front side of the cooking surface.

2. The grill plate of claim 1, wherein the one or more projection members each preferably include a recess configured to mate with the support element.

3. The grill plate of claim 1, wherein the cooking surface slopes downwardly at an angle of less than 10 degrees.

4. The grill plate of claim 1, further comprising a plurality of drain holes located adjacent to the front side of the cooking surface.

5. The grill plate of claim 4, wherein the plurality of drain holes are positioned and located above a drain pan such that cooking byproducts from foodstuffs that pass through the plurality of drain holes may be collected in the drain pan.

6. The grill plate of claim 1, wherein the one or more projection members are aligned along a center of the grill plate.

7. The grill plate of claim 1, wherein the one or more projection members are located at the rear side of the grill plate.

8. The grill plate of claim 1, wherein the grill plate is substantially reversible.

9. A grill plate configured for use within an oven, the grill plate comprising:
a cooking surface; and
a plurality of leg members at a rear side of the cooking surface projecting downwardly from the cooking surface;
wherein the plurality of leg members are configured to cause the cooking surface to slope downwardly from the rear side toward a front side of the cooking surface.

10. The grill plate of claim 9, wherein the plurality of leg members are configured to abut a support element within the oven.

11. The grill plate of claim 10, wherein the plurality of leg members each preferably include a recess configured to mate with the support element.

12. The grill plate of claim 9, wherein the cooking surface slopes downwardly at an angle of less than 10 degrees.

13. The grill plate of claim 9, further comprising a plurality of drain holes located adjacent to the front side of the cooking surface.

14. The grill plate of claim 13, wherein the plurality of drain holes are positioned and located above a drain pan such that cooking byproducts from foodstuffs that pass through the plurality of drain holes may be collected in the drain pan.

15. The grill plate of claim 9, further comprising a plurality of ridges configured to produce grill marks.

16. The grill plate of claim 9, further comprising sidewalls configured to contain cooking byproducts within the grill plate.

17. A grill plate configured for use within an oven, the grill plate comprising:
a cooking surface; and
a plurality of projection members configured to provide a slope to the cooking surface.

18. The grill plate of claim 17, wherein the plurality of projection members are configured to abut a support element within the oven.

19. The grill plate of claim 17, wherein the slope is at an angle of less than 10 degrees.

20. The grill plate of claim 17, further comprising a plurality of drain holes located adjacent to a front side of the cooking surface.
